(19) United States
(12) Patent Application Publication
(10) Pub. No.: US 2023/0222713 A1
(43) Pub. Date: Jul. 13, 2023

(54) DISPLAY CONTROL DEVICE AND DISPLAY CONTROL METHOD

(71) Applicant: Nippon Telegraph and Telephone Corporation, Tokyo (JP)

(72) Inventors: Sayaka YAGI, Musashino-shi, Tokyo (JP); Kimio TSUCHIKAWA, Musashino-shi, Tokyo (JP); Takeshi MASUDA, Musashino-shi, Tokyo (JP); Fumihiro YOKOSE, Musashino-shi, Tokyo (JP); Yuki URABE, Musashino-shi, Tokyo (JP); Haruo OISHI, Musashino-shi, Tokyo (JP)

(21) Appl. No.: 18/009,406

(22) PCT Filed: Jun. 15, 2020
(86) PCT No.: PCT/JP2020/023485

§ 371 Date: Dec. 9, 2022

(51) Int. Cl. G06T 11/20

(52) U.S. Cl. CPC G06T 11/206

(57) ABSTRACT

A display control apparatus (10) generates, based on a hierarchical structure of data items included in an operation log, a graphical object representing a series of operations indicated in the operation log with a node and a link. The display control apparatus (10) generates visualized information in which information indicating a connection relationship between nodes belonging to a lower hierarchical level than that of a node belonging to a first hierarchical level is represented in the node in a nested manner based on the generated graphical object. The information indicating the connection relationship between nodes in the nest is information in which a start node on a first axis in the nest is connected with a link to an end node on a second axis. In addition, the display control apparatus (10) disposes, with respect to a node group of the first hierarchical level in the visualized information, nodes having higher commonality in values of the data items such that they are brought closer to each other.

### TECHNICAL FIELD

The present disclosure relates to a display control apparatus and a display control method.

### BACKGROUND ART

There is a technique in the related art for work analysis using user operation logs. For efficient work analysis using this technique, a node-link representation visualization method represents a series of operations as links connecting nodes including such as applications, windows, and operation targets indicated by operation logs.

This method can represent the connection relationship between the operation logs with the plurality of levels of granularity by hierarchizing operation logs for each level of granularity such as application, window, and operation target and switching hierarchical levels to be displayed. In addition, there is also a method of concurrently representing a connection relationship between a plurality of levels of granularity. For example, there is a method which represents, in each node of the first hierarchical level in a nested manner, a connection relationship between elements included in a first hierarchical level that is a hierarchical level with the highest level of granularity (, which corresponds to the hierarchical level of an application in an operation log) is represented in a node-link form, and a connection relationship between elements included in a second hierarchical level that is a hierarchical level with a lower level of granularity than the first hierarchical level (for example, which corresponds to the hierarchical level of a window or a hierarchical level of an operation target in an operation log) (see NPL 1).

According to these techniques, analysts can intuitively grasp connection relationships of nodes even with operation log data of a relatively large scale.

### CITATION LIST

### Non Patent Literature

NPL 1: M. Baur, U. Brandes, “Multi-Circular Layout of Micro/Macro Graphs”, in International Symposium on Graph Drawing, Springer, Berlin, Heidelberg, pp. 255-267, 2007

### SUMMARY OF THE INVENTION

### Technical Problem

However, because the directions of links connecting nodes are not represented in the above-described related art, analysts have difficulty in grasping transitions of nodes (or their order) in a plurality of hierarchical levels while they can grasp the connection relationship between the nodes in each hierarchical level. For this reason, the analysts cannot grasp the flow of a series of operations even when operation logs are applied in the related art. Further, because, in the related art, only the number of links connected to nodes is used as a condition when the disposition of nodes in the first hierarchical level is determined, in a case in which focus is placed on processing of a certain user or an order (that is a unit for identifying work such as a case or a request), for example, groups of nodes included in the processing are not necessarily disposed close to each other. As a result, analysts unfortunately have difficulty in grasping the flow of remotely disposed operations, which hinders work analysis on operation log data of a large scale from being efficiently analyzed.

Therefore, the present disclosure aims to solve such circumstances and to perform work analysis on operation log data of a large scale efficiently.

### Means for Solving the Problem

To solve above-described problems, the present disclosure includes a first generation unit that generates, according to a hierarchical structure of a plurality of data items included in an operation log, a graphical object representing a series of operations indicated in the operation log with a plurality of nodes and a link connecting the plurality of nodes on a hierarchical level basis, a second generation unit that generates, in a node belonging to a first hierarchical level, according to the generated graphical object, visualized information representing, in a nested manner, information indicating a connection relationship between a start node and an end node belonging to a low hierarchical level of the plurality of nodes by using two parallel axes; and a disposition unit that disposes, with respect to a node group of the first hierarchical level in the visualized information, a plurality of nodes with high commonality in values of the plurality of data items to bring close to each other in accordance with the values of the data items constituting the nodes.

### Effects of the Invention

According to the present disclosure, work analysis on operation log data of a large scale can be efficiently performed.

### BRIEF DESCRIPTION OF DRAWINGS

FIG. 1A is a diagram illustrating examples of visualized information generated by a display control apparatus.

FIG. 1B is a diagram illustrating another example of the visualized information generated by the display control apparatus.

FIG. 2 is a block diagram illustrating an exemplary functional configuration of the display control apparatus.

FIG. 3 is a table illustrating an exemplary data configuration of operation logs.

FIG. 4 is a diagram illustrating exemplary data of a hierarchical structure.

FIG. 5 is a diagram for describing processing to dispose nodes on two Y axes.

FIG. 6 illustrates an exemplary operation in a chronological order performed by a user.

FIG. 7 is a diagram illustrating an exemplary graphical object.

FIG. 8 is a diagram illustrating a line segment connecting two parallel axes generated according to graphical objects.

FIG. 9 is a flowchart illustrating an exemplary procedure of a display control processing.

FIG. 10 is a block diagram illustrating an exemplary computer that executes a display control program.

### DESCRIPTION OF EMBODIMENTS

Hereinafter, exemplary embodiments of the present disclosure will be described in detail with reference to the drawings. Further, the present disclosure is not limited to the embodiments. In addition, identical parts will be denoted by the same reference signs in the description of the drawings.

### Embodiment

### Overview of Display Control Apparatus

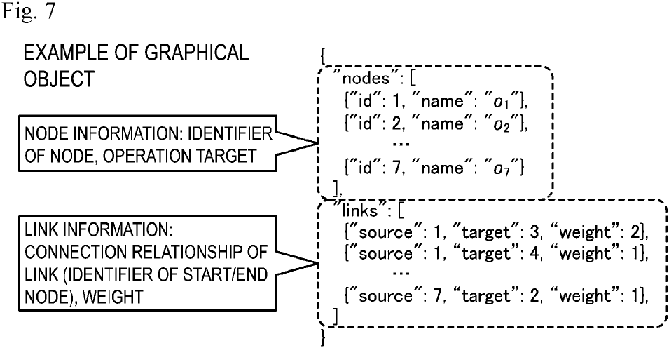

First, an overview of a display control apparatus of the present embodiment will be described. The display control apparatus generates the visualized information in which a series of operations indicated in an operation log is represented by nodes and links for work analysis. Here, first, the display control apparatus generates a graphical object (see FIG. 7) represented by a node group in which a series of operations indicated in an operation log is included in each hierarchical level and a connection relationship of nodes in accordance with the hierarchical structure of data items included in the operation log.

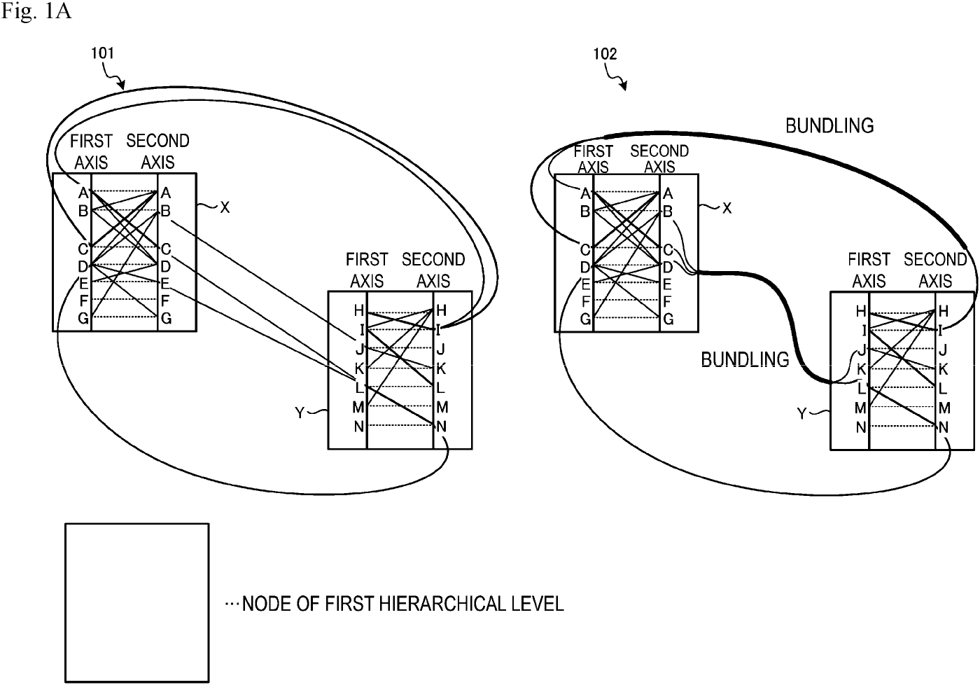

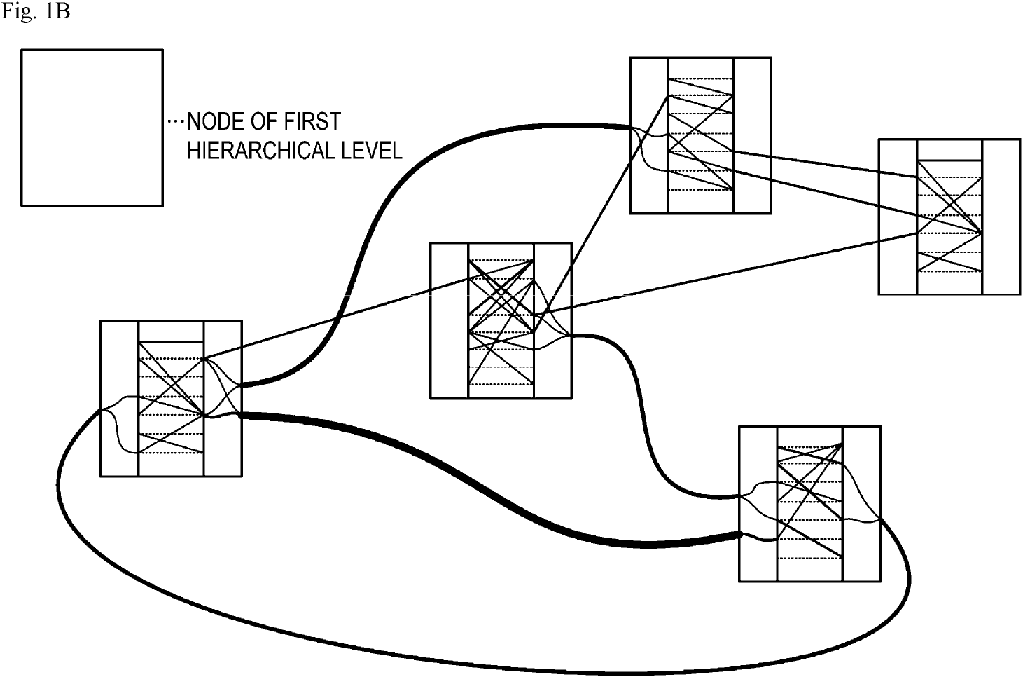

Then, the display control apparatus generates visualized information in which information indicating a connection relationship between nodes belonging to a lower hierarchical level than that of the aforementioned nodes (for example, the hierarchical level of a window and an operation target) in a nesting manner in nodes belonging to a first hierarchical level (for example, the hierarchical level of an application) in accordance with the generated graphical object (see reference sign 101 in FIG. 1A). Here, in the visualized information, the information indicating the connection relationship between the nodes belonging to the lower hierarchical level is represented using two parallel axes and links connecting the nodes disposed on the two axes.

For example, the display control apparatus generates visualized information as indicated by the reference sign 101 in FIG. 1A in which, in a connection relationship from a node A belonging to a lower hierarchical level than that of a node X in a first hierarchical level to a node C, the node A disposed on a first axis is connected with a link to the node C disposed on a second axis in the node X.

In addition, if there is a connection relationship between nodes belonging to lower hierarchical levels (second and third hierarchical levels), the relationship spanning across nodes belonging to the first hierarchical level, the display control apparatus generates visualized information in which the start node disposed on the second axis in the node in the first hierarchical level is connected with a link to the end node disposed on the first axis in the node in the first hierarchical level to which the end node belongs.

For example, as indicated by the reference sign 101 in FIG. 1A, a connection relationship of a node B to a node J is a connection relationship spanning across the nodes X and Y in the first hierarchical level. Thus, the display control apparatus generates visualized information in which the node B of the node X on the second axis is connected with a link to the node J in the node Y on the first axis.

According to such visualized information, the analyst can easily grasp the connection relationships and transitions of the nodes in a plurality of hierarchical levels (levels of granularity) simultaneously. As a result, the analyst can easily narrow down the portion to be analyzed by digging down to a lower hierarchical level in the representation of the visualized information.

In addition, when generating the visualized information described above, the display control apparatus disposes nodes with higher commonality in values of a data item constituting a node closer to each other with respect to a node group of the first hierarchical level.

For example, the display control apparatus generates visualized information in which identification information of a user name, an operation time, an order, and the like of each of the nodes X and Y indicated by the reference sign 101 in FIG. 1A is set to variables, and the nodes X and Y are disposed to be closer to each other when values of the variables have higher commonality. According to such visualized information, the analyst can easily track connection relationships between nodes, focusing on some users or orders.

When generating visualized information, the display control apparatus bundles link groups having the same combination of the start node and the end node and the same direction of a link among link groups connecting the nodes of the first hierarchical level (see reference sign 102 in FIG. 1A). The bundling mentioned here refers to processing of deforming or integrating links such that link groups connected to an adjacent node are smoothly bundled and visualized. According to such visualized information, the analyst can easily grasp the connection relationships between the nodes in the first hierarchical level.

Further, the visualized information can also represent a connection relationship between the nodes that is more complex than that in FIG. 1A, as illustrated in FIG. 1B, for example. According to such visualized information, the analyst can easily grasp the connection relationships between the nodes and transitions in a plurality of hierarchical levels. As a result, the analyst can efficiently perform work analysis on operation log data of a large scale.

### Configuration of Display Control Apparatus

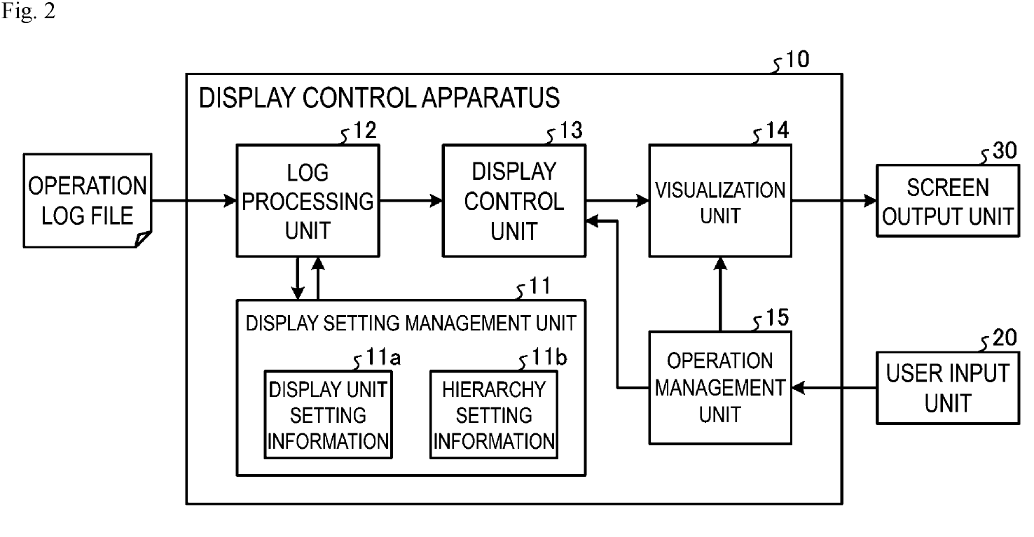

Next, an exemplary configuration of the display control apparatus 10 will be described with reference to FIG. 2. The display control apparatus 10 is connected to a user input unit 20 that receives operations of an analyst and a screen output unit 30 that outputs screens, as illustrated in FIG. 2, for example. Further, the user input unit 20 and the screen output unit 30 may be included in the display control apparatus 10 or may be included in the same apparatus or different apparatuses.

The display control apparatus 10 receives inputs of operation log files.

An operation log file includes information in units of multiple operations. An operation log is information indicating, for example, terminal information, login user information, application information, window information, operation content, and occurrence time. The window information is, for example, a window title, a URL/file path, or a window handle. The operation content is, for example, an operation target, an operation type, a value, and a captured image and is recorded when an operation is made on an object in a window.

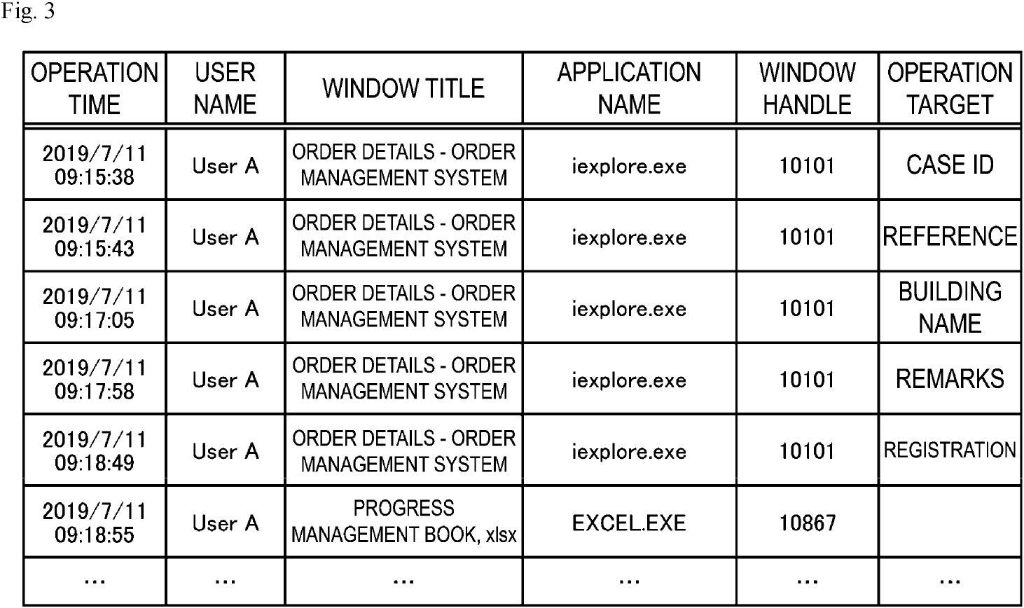

An operation log is information in which, for example, an operation time (operation date and time) of the user with respect to a window, the user name, the window title of an operation target, the application name used in the window, and the window handle are recorded when the state of the window has changed on the screen of a terminal, as illustrated in FIG. 3.

In addition, the operation log further includes the operation time for an object recorded when the operation is made for the object in the window, and the information of the operation target. An operation target is an identifier of a GUI component included in the window of the operation target. Although the example of FIG. 3 shows the names of items of an operation target, names of items may include IDs or name attributes in the case of a browser, or may be coordinate information in the case of a window with a fixed screen structure. In addition, the operation log may include a captured image of the window operated at the operation time, the operation type, the value input through the operation, and the like.

The display control apparatus 10 is implemented, for example, by causing a computer including a read only memory (ROM), a random access memory (RAM), a central processing unit (CPU), and the like to read a predetermined program and the CPU to execute the predetermined program. In addition, the display control apparatus 10 has a communication interface on which the display control apparatus can transmits and receives various kinds of information to and from another apparatus connected via a network or the like. For example, the display control apparatus 10 includes, for example, a network interface card (NIC) and communicate with another apparatus via an electrical communication line such as a local area network (LAN) or the Internet.

Description will be provided with reference to FIG. 2 again. The display control apparatus 10 includes, for example, a display setting management unit 11, a log processing unit (first generation unit) 12, a display control unit (disposition unit) 13, a visualization unit (second generation unit) 14, and an operation management unit 15 as illustrated in FIG. 2.

The display setting management unit 11 stores display unit setting information 11a and hierarchy setting information 11b. The display setting management unit 11 is implemented by a semiconductor memory element such as a RAM or a flash memory, or a storage device such as a hard disk or an optical disc. Although the display unit setting information 11a and the hierarchy setting information 11b are setting information set in advance, the information can be changed manually or automatically.

The display unit setting information 11a is information for classifying an operation log and generating event data. For example, the display unit setting information 11a is information indicating the unit in which a connection relationship is desired to be indicated, such as a user and an order and is information referred to by the log processing unit 12 to be described below.

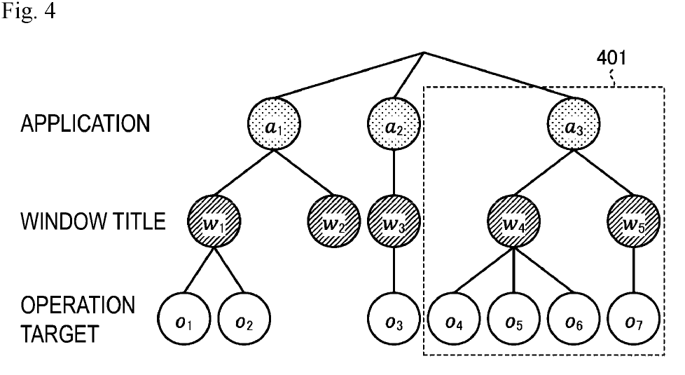

The hierarchy setting information 11b is information for generating a hierarchical structure (a tree structure; see FIG. 4) of nodes from an operation log. For example, the hierarchy setting information 11b is information indicating the names of items in each hierarchical level and the order, and is information referred to, by the log processing unit 12 to be described below.

The log processing unit 12 generates data indicating a hierarchical structure (a tree structure) for each node in accordance with data items included in an operation log. For example, the log processing unit 12 generates a tree structure of a node with reference to the hierarchy setting information 11b in accordance with data items included in an operation log. For example, when a hierarchical structure for data items that are an application, a window title, and an operation target is set in the hierarchy setting information 11b, the log processing unit 12 nests these data items as keys and thereby generates data in a hierarchical structure illustrated in FIG. 4.

In addition, the log processing unit 12 generates event data including an object obtained by classifying an operation log in units of display (for example, units of user, or the like) set in advance. For example, the log processing unit 12 generates event data including an object obtained by classifying an operation log using the unit indicated in the display unit setting information 11a as a key. Further, the log processing unit 12 arranges objects included in the event data in a chronological order.

Furthermore, the log processing unit 12 uses the data in the hierarchical structure of each node and the event data described above to generate a graphical object indicating a plurality of nodes expressed by elements included in a predetermined hierarchical level and a connection relationship of the nodes. For example, the log processing unit 12 uses the data in the hierarchical structure of each node to generate a graphical object (see FIG. 7) including a node group (node information) expressed in a predetermined hierarchical level (for example, a unit of application, a unit of window title unit, or a unit of operation target) and a link group (link information) indicating a connection relationship between nodes using the event data.

Here, with respect to the node information of the first hierarchical level, it is assumed that multidimensional variables can be given as node information in addition to the items shown in FIG. 7 to realize disposition with a value of a data item (for example, identification information of user name, operation time, or order) constituting each node added. For example, it is possible to include the following variables calculated for each node as the node information of the first hierarchical level.
List of users included in a corresponding node
List of orders included in a corresponding node
Total value of duration of operation events for a corresponding node

The display control unit (disposition unit) 13 determines a disposition of each object in visualized information in accordance with a graphical object. For instance, the display control unit 13 disposes the node group of the first hierarchical level so that nodes having higher commonality in the value of variables are brought closer to each other, in accordance with the above variables included in each node.

Specifically, the display control unit 13 calculates the inter-node distance using the value of the variables described above for any node pair included in the first hierarchical level. Then, the display control unit 13 determines the disposition of each node using a predetermined dynamics model (for example, see the following Documents 1, 2, and 3) by processing, such as reflecting the calculated inter-node distance in a repulsive force acting between the nodes, or connecting the nodes in a predetermined distance or shorter with a virtual link and reflecting the distance in an attracting force acting between the links. Further, the display control unit 13 is assumed to reflect the number of links connected to each node, for example, as a weight of the link, in order to determine the disposition of each node.

Document 1: P. Eades, “A Heuristic for Graph Drawing”, Congressus Numerantium 42, pp. 149-160, 1984.

Document 2: T. M. J. Fruchterman and E. M. Reingold, “Graph Drawing by Force-directed Placement”, Software: Practice and Experience, Vol. 21, pp. 1129-1164, 1991.

Document 3: T. Kamada and S. Kawai, “An Algorithm for Drawing General Undirected Graphs”, Information Processing Letters, Vol. 31, No. 1, pp. 7-15, 1989.

Further, the display control unit 13 determines the arrangement (coordinate positions) of the nodes in the second and third hierarchical levels on the Y axis according to the graphical obj ect.

The visualization unit 14 determines the attribute value of each object in accordance with the coordinate position of each object determined by the graphical object and the display control unit 13, draws visualized information, and outputs the visualized information to the screen output unit 30 to display the screen.

For example, the visualization unit 14 generates the visualized information expressing information indicating the connection relationship from the start node to the end node belonging to the lower hierarchical level (for example, the second and third hierarchical level) than that of a corresponding node to be nested in the node belonging to the highest hierarchical level (the first hierarchical level) among the hierarchical levels, in accordance with the coordinate position of each object determined by the display control unit 13.

Further, the connection relationship from the start node to the end node is expressed such that, for example, the start node on the first axis disposed in the node belonging to the first hierarchical level is connected to the end node on the second axis disposed parallel to the first axis (see the reference sign 101 in FIG. 1A). Because the direction of the link from the start node to the end node is expressed in the visualized information as described above, the analyst can easily grasp the flow of the series of operations.

Further, there is a connection relationship between the nodes belonging to lower hierarchical levels than the first hierarchical level, the connection relationship spanning across nodes belonging to the first hierarchical level, the connection relationship from the start node to the end node is expressed such that the start node on the second axis disposed in the node of the first hierarchical level is connected to the end node on the first axis disposed in the node of the first hierarchical level to which the end node belongs (see the reference sign 101 in FIG. 1A). Because the connection relationship between the nodes of the second and third hierarchical levels spanning across the nodes of the first hierarchical level is expressed in the visualized information as described above, the analyst can easily grasp the flow of the series of operations spanning across the nodes of the first hierarchical level.

In addition, when the visualized information is drawn, the visualization unit 14 bundles (clusters) link groups having the same starting points and end points of the first hierarchical level and links in the same direction (see reference sign 102 in FIG. 1A). For example, if there are a predetermined number of links or more having the same starting points and end points of the first hierarchical level and links in the same direction, the visualization unit 14 bundles such link groups. With this operation, the analyst can easily grasp the connection relationships between the nodes from a macro perspective.

The operation management unit 15 receives the input of the user for the result of the drawn visualized information from the user input unit 20, and reflects the input of the user in the visualized information. For example, if the input of the user is an operation to request re-drawing of a link or a node (for example, movement of the node, etc.), the operation management unit 15 notifies the display control unit 13 of operation targets to cause the operation targets to be re-disposed. For example, if the input of the user is an operation without requesting re-drawing of the visualized information, such as a highlighted display of a link (for example, application or cancellation of bundling of links, or highlighted display of a link), the operation management unit 15 notifies the visualization unit 14 of elements of operation targets.

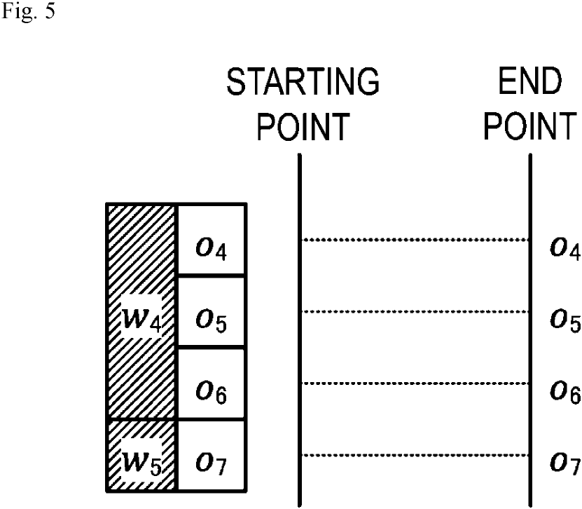

Here, exemplary information indicating a connection relationship between nodes of the second and third hierarchical levels will be described using FIG. 5. For example, the display control unit 13 divides the Y axis into the number of nodes in the lower hierarchical levels than a node a₃ belonging to the first hierarchical level indicated by reference sign 401 of FIG. 4, as illustrated in FIG. 5. For example, the display control unit 13 divides the Y axis indicating the starting point and the Y axis indicating the end point into four that is the number of nodes of operation targets that are nodes in the lower hierarchical levels than that of the node a₃. Then, the display control unit 13 determines positions of the nodes on the Y axis (positions of each of the nodes of the operation target as indicated by dashed lines connecting the axes in FIG. 5).

Further, the disposition of the nodes of each hierarchical level on the Y axis is assumed to be determined in a predetermined order. For example, the disposition of the node of the “operation target” on the Y axis, which is a node in the third hierarchical level is determined according to the disposition of the operation target on the GUI in the window. In addition, for example, the disposition of a “window” that is a node in the second hierarchical level on the Y axis is determined to be adjacent to a window having a large number of connections of elements.

Further, any method may be used for the expression method of the hierarchical structures of the second and third hierarchical levels, and the hierarchical structures of the second and third hierarchical levels may be expressed in the shape of Icicle plot in which each hierarchical level is expressed in rectangular shapes as illustrated on the left side of FIG. 5, or an upper hierarchical level may be represented in a list such that the same elements are adjacent to each other only with respect to the lowest hierarchical level (for example, an operation target).

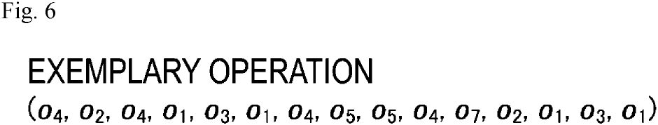

Here, processing of the log processing unit 12 to generate a graphical object from two consecutive elements for a hierarchical level to be drawn will be described using the examples of FIGS. 6 and 7. Here, it is assumed that the hierarchical level to be drawn is an “operation target” in the lowest hierarchical level. A case in which the display control unit 13 sequentially extracts two consecutive elements from an operation sequence as two continuous elements to generate a graphical object will be exemplified.

For example, the log processing unit 12 generates the graphical object illustrated in FIG. 7 from the operation sequence illustrated in FIG. 6. The log processing unit 12 generates a graphical object including IDs that are identifiers of nodes and names of operation targets that are node information of each of nodes O₁ to O₇, as a graphical object, as exemplified in FIG. 7. In addition, the display control unit 13 generates a graphical object including the IDs of the start nodes, the IDs of the end nodes, and weights as link information indicating connection relationships between nodes. Here, although the weights indicate the number of links having the same start node and end node (a frequency of appearance of operation sequences), the time taken for a transition of an operation or the like may be set as a weight.

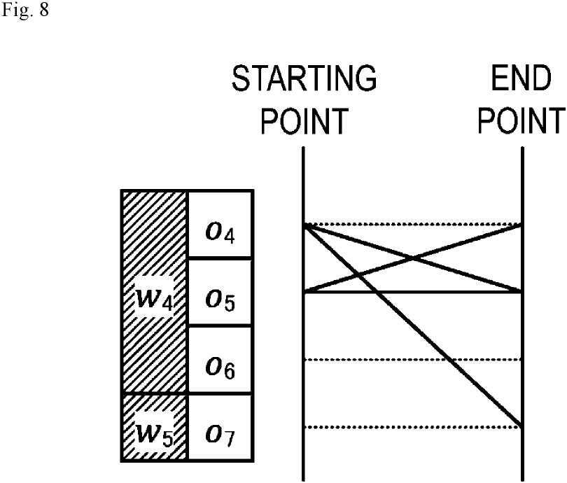

Thereafter, the visualization unit 14 draws information indicating the connection relationship between nodes of the second and third hierarchical levels to be nested in the node of the first hierarchical level using the graphical object. There is a connection relationship of O₄ to O₅, O₅ to O₄, O₅ to O₅, and O₄ to O₇, for example, the visualization unit 14 connects O₄ disposed on the Y axis indicating the starting point to O₅ disposed on the Y axis indicating the end point, as illustrated in FIG. 8. In addition, the visualization unit 14 connects O₅ disposed on the Y axis indicating the starting point to O₄ disposed on the Y axis indicating the end point. Likewise, the visualization unit 14 connects O₅ disposed on the Y axis indicating the starting point to O₅ disposed on the Y axis indicating the end point, and O₄ disposed on the Y axis indicating the starting point to O₇ disposed on the Y axis indicating the end point.

### Procedure of Display Control Processing

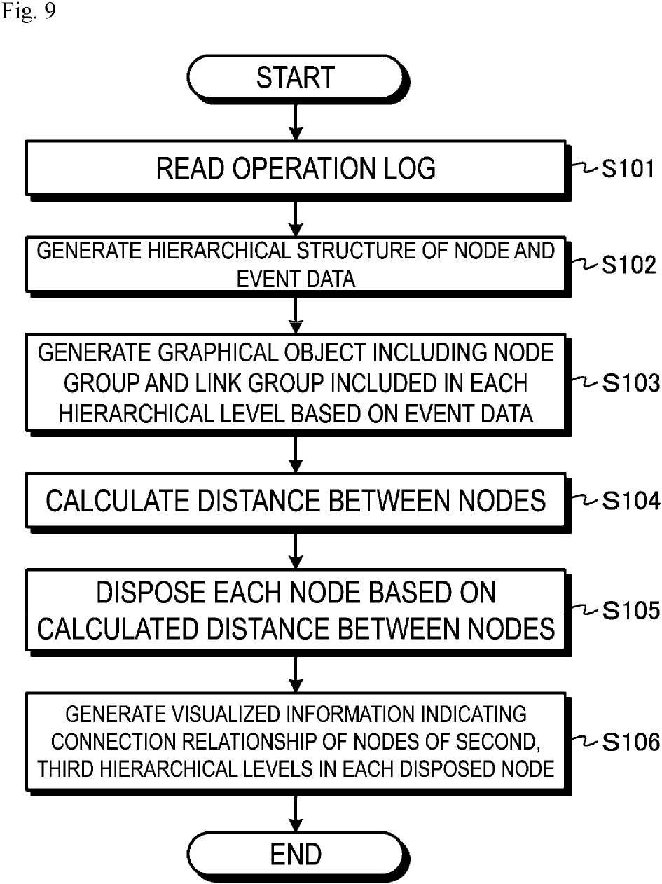

Next, an exemplary procedure of display control processing performed by the display control apparatus 10 will be described with reference to FIG. 9.

First, the log processing unit 12 of the display control apparatus 10 reads an operation log to be displayed (S101). Then, the log processing unit 12 generates a hierarchical structure of nodes in accordance with the data items included in the operation log. In addition, the log processing unit 12 generates event data including an object obtained by classifying the operation log in units of display set in advance (S102: generation of a hierarchical structure of nodes and event data). Then, the log processing unit 12 generates a graphical object including a node group and a link group included in each hierarchical level using the hierarchical structure and event data generated in S102 (S103).

Then, the display control unit 13 calculates the distance between the nodes of the first hierarchical level (S104). For instance, the display control unit 13 calculates an inter-node distance using the value of the variables described above for any node pair included in the first hierarchical level. Then, the display control unit 13 disposes each of the nodes in accordance with the inter-node distances calculated in S104 (S105). For example, the display control unit 13 determines the disposition of each node in accordance with a predetermined dynamic model by processing, such as reflecting the inter-node distance calculated in S105 in a repulsive force between the nodes, or connecting the nodes in a predetermined distance or shorter with a virtual link and reflecting the distance in an attracting force of the link.

Thereafter, the visualization unit 14 generates visualized information indicating the connection relationship between the nodes of the second and third hierarchical levels in each node of the first hierarchical level disposed by the display control unit 13 in S105 (S106).

For example, the visualization unit 14 generates the visualized information expressing information indicating the connection relationship between the nodes belonging to the second and third hierarchical levels to be nested in the node belonging to the first hierarchical level in accordance with the coordinate position of each object determined by the display control unit 13.

Here, the visualization unit 14 expresses the connection relationship between the nodes belonging to the second and third hierarchical levels described above, for example, such that the start node on the first axis is connected with a link to the end node on the second axis disposed parallel to the first axis as indicated by the reference sign 101 in FIG. 1A. In addition, in a case in which there is a connection relationship between nodes belonging to the second and third hierarchical levels, the relationship spanning across the nodes belonging to the first hierarchical level, the visualization unit 14 expresses the connection relationship between the nodes belonging to the second and third hierarchical levels by, for example, connecting with a link the start node on the second axis in the node of the first hierarchical level to which the start node of the connection relationship belongs to the end node on the first axis in the node of the first hierarchical level to which the end node of the connection relationship belongs.

For example, a case in which nodes A to G belong to a node X of the first hierarchical level, and nodes H to N belong to a node Y of the first hierarchical level as indicated by the reference sign 101 in FIG. 1A is considered. In this case, the visualization unit 14 expresses the connection relationship between the nodes present in the same first hierarchical level by connecting with a link the start node on the first axis to the end node on the second axis.

For example, for the connection relationship of the node A to the node C in the node X, the visualization unit 14 connects with a link the node A on the first axis in the node X to the node C on the second axis in the node X.

On the other hand, the visualization unit 14 expresses the connection relationship between nodes spanning across the nodes of the first hierarchical levels by connecting with a link the start node on the second axis in the node of the first hierarchical level to which the start node belongs to the end node on the first axis in the node of the first hierarchical level to which the end node belongs.

For example, the visualization unit 14 expresses a connection relationship of the node B in the node X to the node J in the node Y by connecting with a link the node B on the second axis in the node X to the node J on the first axis in the node Y. In addition, the visualization unit 14 likewise expresses the connection relationships between nodes spanning across the nodes of the first hierarchical level with respect to the node C to the node L, the node E to the node L, the node I to the node A, the node I to the node C, and the node N to the node D by connecting, with a link, the node on the second axis of the node X to the node on the first axis of the node Y.

In this way, for example, the analyst can easily keep track of the flow of an operation spanning across the nodes belonging to the first hierarchical level (for example, the flow of an operation from the node D to the node B and to the node J). In addition, although the first axis in the node of the first hierarchical level is located on the left side and the second axis is located on the right side in FIG. 1A, the locations are not limited thereto. For example, the first axis in the node of the first hierarchical level may be disposed on the right side and the second axis may be disposed on the left side. Alternatively, the first axis may be fixed as an axis indicating a starting point, and the second axis may be fixed as an axis indicating an end point. In this case, for example, the link connecting the node B on the second axis in the node X to the node J on the first axis in the node Y in FIG. 1A indicates a connection relationship between the node J (starting point) on the first axis in the node Y and the node B (end point) on the second axis in the node X.

In addition, the visualization unit 14 bundles link groups having the same starting points and end points of the first hierarchical level of the first hierarchical level and links in the same direction.

For example, among links having a node in the node Y as a starting point and a node in the node X as an end point in the connection relationship indicated by the reference sign 101 of FIG. 1A, the visualization unit 14 bundles the link from the node I to the node A and the link from the node I to the node C. In addition, among links having a node in the node X as a starting point and a node in the node Y as an end point, the visualization unit 14 bundles the link from the node B to the node J, the link from the node C to the node L, and the link from the node E to the node L.

In this way, the visualization unit 14 can generate visualized information from which the analyst can visually recognize the connection relationship between nodes of the first hierarchical level with ease.

Further, the visualization unit 14 may reflect an attribute value such as, for example, an operation time, a degree of dispersion of the operation locations, and the type of user, or the type of order, in an attribute value of the size, the color, and the like of a node of the visualized information. In this way, the analyst can easily compare a plurality of users, a plurality of orders, or the like in the visualized information. In addition, an expression in which shapes of attribute values of links have arrow shapes or the like, and the hue, brightness, and the like thereof are changed to have gradations at the starting points and end points may be employed. In this way, the analyst can grasp the flow of operations more easily.

### System Configuration of Embodiment

Each constituent component of the display control apparatus 10 illustrated in FIG. 2 is functionally conceptual and may not necessarily be physically configured as in the drawings. That is, a specific form of distribution and integration of the functions of the display control apparatus 10 is not limited to the illustrated form, and the entirety or a portion of the form can be configured by being functionally or physically distributed and integrated in any unit, according to various loads, usage conditions, and the like.

In addition, all or some of each processing operation performed in the display control apparatus 10 may be implemented using a CPU, a graphics processing unit (GPU), and a program that is analyzed and executed by the CPU or the GPU. Each processing operation performed by the display control apparatus 10 may be also implemented by hardware in a wired logic.

Further, all or some of the processing operations described as being performed automatically among the processing operations described in the embodiment can be performed manually. Alternatively, all or some of the processing operations described as being performed manually can be performed automatically using a known method. In addition, information including the processing procedures, control procedures, specific names, and various types of data or parameters described above and illustrated in the drawings can be appropriately changed unless otherwise specified.

### Program

Furthermore, the functions of the display control apparatus 10 described in the embodiments described above can be implemented by installing a program (display control program) that achieves such functions into a desired information processing apparatus (computer). For example, by causing a computer to execute the above-described program provided as package software or online software, the computer can function as the display control apparatus 10. The computer referred to here includes a desktop or laptop personal computer, a rack-mounted server computer, and the like. In addition, a smartphone, a mobile phone, a mobile communication terminal such as a personal handyphone system (PHS), a personal digital assistants (PDA), and the like are included in a category of the computer. Furthermore, the functions of the display control apparatus 10 may be implemented in a cloud server.

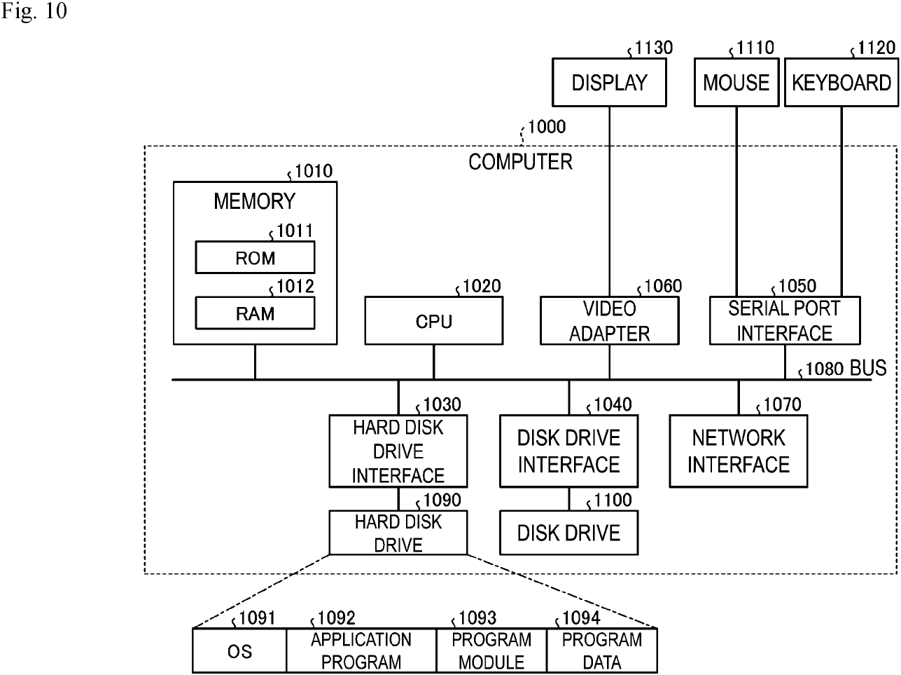

FIG. 10 is a diagram illustrating an exemplary computer that executes a display control program. The computer 1000 includes, for example, a memory 1010 and a CPU 1020. Further, the computer 1000 includes a hard disk drive interface 1030, a disk drive interface 1040, a serial port interface 1050, a video adapter 1060, and a network interface 1070. These units are connected by a bus 1080.

The memory 1010 includes a ROM 1011 and a RAM 1012. The ROM 1011 stores, for example, a boot program such as a basic input output system (BIOS). The hard disk drive interface 1030 is connected to a hard disk drive 1090. The disk drive interface 1040 is connected to a disk drive 1100. For example, a removable storage medium such as a magnetic disk or an optical disk is inserted into the disk drive 1100. The serial port interface 1050 is connected to, for example, a mouse 1110 and a keyboard 1120. The video adapter 1060 is connected to, for example, a display 1130.

The hard disk drive 1090 stores, for example, an operating system (OS) 1091, an application program 1092, a program module 1093, and program data 1094. That is, the program defining each processing operation of the display control apparatus 10 is implemented as the program module 1093 in which codes executable by the computer 1000 are described. The program module 1093 is stored in, for example, the hard disk drive 1090. For example, the program module 1093 for executing processing similar to the functional configuration of the display control apparatus 10 is stored in the hard disk drive 1090. The hard disk drive 1090 may be replaced with a solid state drive (SSD).

Further, configuration data to be used in the processing of the embodiment described above is stored as the program data 1094 in, for example, the memory 1010 or the hard disk drive 1090. The CPU 1020 reads the program module 1093 and the program data 1094 stored in the memory 1010 or the hard disk drive 1090 into the RAM 1012 and executes the program module 1093 and the program data 1094, as necessary.

The program module 1093 and the program data 1094 are not limited to being stored in the hard disk drive 1090 and may be stored, for example, in a removable storage medium and read by the CPU 1020 via the disk drive 1100 or the like. Alternatively, the program module 1093 and the program data 1094 may be stored in other computers connected via a network (a Local Area Network (LAN), a Wide Area Network (WAN), or the like). In addition, the program module 1093 and the program data 1094 may be read by the CPU 1020 from another computer through the network interface 1070.

Although the embodiment to which the invention made by the present inventor is applied has been described above, the present invention is not limited by the description and the drawings which constitute a part of the disclosure of the present invention according to the present embodiment. That is, other embodiments, examples, operation technologies, and the like made by those skilled in the art based on the present embodiment are all included in the scope of the present invention.

### REFERENCE SIGNS LIST

10 Display control apparatus
11 Display setting management unit
11a Display unit setting information
11b Hierarchy setting information
12 Log processing unit (first generation unit)
13 Display control unit (disposition unit)
14 Visualization unit (second generation unit)
15 Operation management unit
20 User input unit
30 Screen output unit

1. A display control apparatus comprising:
a first generation unit, implemented using one or more computing devices, configured to generate, in accordance with a hierarchical structure of a plurality of data items included in an operation log, a graphical object representing a series of operations indicated in the operation log with a first plurality of nodes and a link connecting the first plurality of nodes on a hierarchical level basis;
a second generation unit, implemented using one or more computing devices, configured to generate, in a node at a first hierarchical level, according to the generated graphical object, visualized information representing, in a nested manner, information indicating a connection relationship between a start node and an end node that are at a lower hierarchical level of the first plurality of nodes by using two parallel axes; and
a disposition unit, implemented using one or more computing devices, configured to dispose, with respect to a node group of the first hierarchical level in the visualized information, a second plurality of nodes with high commonality in values of the plurality of data items at a distance relative to each other, among the first plurality of nodes, in accordance with the values of the data items including the second plurality of nodes.

2. The display control apparatus according to claim 1,
wherein the information indicating the connection relationship between the start node and the end node is information in which a start node on a first axis disposed in the first plurality of nodes at the first hierarchical level is connected with a link to an end node on a second axis disposed parallel to the first axis.

3. The display control apparatus according to claim 2,
wherein, based on the nodes at a low hierarchical level in the first hierarchical level having a connection relationship across the nodes at the first hierarchical level, the information indicated by using the connection relationship between the start node and the end node is information in which the start node on a second axis in the nodes of the first hierarchical level to which the start node belongs is connected with a link to the end node on a first axis in the nodes of the first hierarchical level to which the end node belongs.

4. The display control apparatus according to claim 1,
wherein the disposition unit disposes, with respect to the node group of the first hierarchical level in the visualized information, the second plurality of nodes with high commonality in values of the plurality of data items next to each other in accordance with the values of the data items of at least one of a user name, an operation time, or an order identification information of an operation indicating the node.

5. The display control apparatus according to claim 1,
wherein the disposition unit is configured to:
calculate a distance between the first plurality of nodes using values of a plurality of data items including the second plurality of nodes when disposing the second plurality of nodes, and
determine disposition of the second plurality of nodes in accordance with a predetermined dynamics model by reflecting the distance between the second plurality of nodes in a repulsive force or an attracting force acting between the second plurality of nodes.

6. The display control apparatus according to claim 1,
wherein, when generating the visualized information, the second generation unit bundles, among a plurality of link groups connecting nodes of the first hierarchical level, a plurality of link groups having a same combination of a start node and an end node and having a same link direction.

7. A display control method performed by a display control apparatus, the display control method comprising:
generating, according to a hierarchical structure of a plurality of data items included in an operation log, a graphical object representing a series of operations indicated in the operation log with a first plurality of nodes and a link connecting the first plurality of nodes on a hierarchical level basis;
generating, in a node belonging to a first hierarchical level, according to the generated graphical object, visualized information representing, in a nested manner, information indicating a connection relationship between a start node and an end node that are at a lower hierarchical level of the first plurality of nodes by using two parallel axes; and
disposing, with respect to a node group of the first hierarchical level in the visualized information, a second plurality of nodes with high commonality in values of the plurality of data items at a distance relative to each other, among the first plurality of nodes, in accordance with the values of the data items including the second plurality of nodes.

8. The display control method according to claim 7,
wherein the information indicating the connection relationship between the start node and the end node is information in which a start node on a first axis disposed in the first plurality of nodes at the first hierarchical level is connected with a link to an end node on a second axis disposed parallel to the first axis.

9. The display control method according to claim 8,
wherein, based on the nodes at a low hierarchical level in the first hierarchical level having a connection relationship across the nodes at the first hierarchical level, the information indicated by using the connection relationship between the start node and the end node is information in which the start node on a second axis in the nodes of the first hierarchical level to which the start node belongs is connected with a link to the end node on a first axis in the nodes of the first hierarchical level to which the end node belongs.

10. The display control method according to claim 7,
disposing the second plurality of nodes comprises disposing, with respect to the node group of the first hierarchical level in the visualized information, the second plurality of nodes with high commonality in values of the plurality of data items next to each other in accordance with the values of the data items of at least one of a user name, an operation time, or an order identification information of an operation indicating the node.

11. The display control method to claim 7, further comprising:
calculating a distance between the first plurality of nodes using values of a plurality of data items including the second plurality of nodes when disposing the second plurality of nodes, and
determininge disposition of the second plurality of nodes in accordance with a predetermined dynamics model by reflecting the distance between the second plurality of nodes in a repulsive force or an attracting force acting between the second plurality of nodes.

12. The display control method according to claim 7, further comprising:
when generating the visualized information, bundling, among a plurality of link groups connecting nodes of the first hierarchical level, a plurality of link groups having a same combination of a start node and an end node and having a same link direction.
